(19) United States
(12) Patent Application Publication
(10) Pub. No.: US 2008/0320036 A1
(43) Pub. Date: Dec. 25, 2008

(54) AUTOMATIC DATA COLLECTION

(76) Inventor: Gentle E. Winter, Los Angeles, CA (US)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 12/144,355

(22) Filed: Jun. 23, 2008

Related U.S. Application Data
(60) Provisional application No. 60/945,880, filed on Jun. 22, 2007.

(51) Int. Cl. G06F 17/30

(52) U.S. Cl. 707/103 R; 707/E17.004

(57) ABSTRACT

A system for capturing and indexing information including a data capture device, a metadata collection component and a data transmission component. In operation the data capture device, metadata collection component, and transmission component are integrated with the data capture device.

### CROSS REFERENCE

The Applicant claims the benefit of Provisional Application, Ser. No. 60/945,880, filed Jun. 22, 2007.

### BACKGROUND

1. Field of the Invention

The invention relates to the automatic capture of data, especially as it relates with mobile systems.

2. Brief Discussion of Related Art

Information, like knowledge, is often priceless. With the reduced costs of data capture devices and storage, it is increasing possible to capture and store large quantities of information. The current problem is that it is difficult to sift though large quantities of information and extract meaningful details. Further, much of the data captured today is not properly indexed, and thus even important data may be rendered meaningless without contextual data. Thus, there is a need to capture data in a manner that allows for later retrieval and meaningful use.

### BRIEF SUMMARY OF THE DRAWINGS

The novel features believed characteristic of the invention are set forth in the appended claims. The drawing herein presented are representative and, unless otherwise stated, are not necessarily drawn to scale and should be used gain a better understanding of the embodiments and not to limit the embodiments. The invention itself, however, as well as a preferred mode of use, further objectives and advantages/thereof, will best be understood by reference to the following detailed description of an illustrative embodiment when read in conjunction with the accompanying drawings, wherein:

FIG. 1 is an embodiment of the present invention where the vehicle is an automobile;

FIG. 2 is an embodiment shown in operation;

FIG. 3 is an alternative embodiment of the present invention suspended in a lighter than air vehicle;

FIG. 4 is a visual depiction of a user selection process whereby certain users are selected based on orientation and proximity;

FIG. 5 is an implementation of the extent code algorithm.

### SUMMARY OF THE INVENTION

In one embodiment of the present invention, a system for capturing data from geographically dispersed areas is provided. This system includes a means for capturing image data. In some embodiments, this is a CCD camera, or other camera device. Further, a means for storing image data, such as an optical, magnetic, or electrical storage device is provided. Additionally a means for capturing and storing metadata, as well as a means for associating meta data with recorded image data and a means for providing the metadata to a database. In operation, the means for capturing image data is configured to convey captured image data to the means for storing image data, and the means for capturing the metadata is configured to convey captured meta data to the means for storing metadata. The means for associating meta data with image data is configured to temporally inter-relate the recorded image data with associated meta data, and the means for providing the metadata to the database provides the metadata to a searchable database. It is contemplated that the metadata may be provided in real time or with greater frequency than the regular data is provided. In another embodiment, the metadata will only be provided when there is a change in metadata. For example if orientation and location remain fixed these may not be reported, or may be reported less frequently. In another embodiment, the incidence of reporting of metadata is proportional to have fast the metadata is changing, or the rate of change. By may of non-limiting example, consider a vehicle on cruise control even though position is changing, the change is in a predictable manner, and the reporting might be done less frequently, now if the car should suddenly slow down the change in speed, or deceleration, would prompt the metadata to report at a high frequency. This feature would allow a viewer of the metadata to more immediately identify places of interest. In the case of traffic flow, it would be possible to identify locations where traffic slows. It should be noted that the invention includes at least general forms, the first being an aggregated report where trends and observations are viewed through the lens of thousands of reports, the second is where specific events are observed (for instance a traffic collision). In the latter case, a single data or metadata point may be the desired component.

In another embodiment, the means for providing metadata to a database allows the data to be provided anonymously. Similarly, the actual data, associated with the metadata may be provided to the database in an anonymous manner.

Generally, the metadata is searchable using one or more of the following: location, time, coordinates, orientation, keyword, and category. The category may be selected environment, such as a road, store, outdoor market, demonstration.

In another embodiment, the metadata includes coordinates based a satellite system. A GPS unit might be used in such a situation. A terrestrially based system may also be used in determining coordinates where the data is being recorded. A cellular phone network may be used in this context. Of course, other systems could also be used, such as commercial radio stations, beacons or other terrestrially based systems. In some embodiments, the user will define the location. Time is also a contemplated component, this would, in a preferred embodiment, be recorded as opposed to provided by a user. The clock could be a clock, which is updated electronically. Such a clock is sold under the trade name SKYSCAN™. Orientation may be captured using a directional sensor, a compass or through recognition of landmarks or other terrestrial, lunar or solar based systems. In some embodiments, a software algorithm will rely on identified subject matter to identify coordinates. Such a system may include text recognition from billboards, roadway signs, exit signs, mile makers etc. In the case of roadway signs a sign indicating that Western Avenue is 2.5 miles may allow a protocol to determine that the recorder is about 2.5 miles from the Western Avenue. Other indicia may indicate that the recorder is northbound on Interstate 10. Tying into a vehicle's on board computer would allow the system to know distances traveled. The shapes of object, building etc allows the system to determine coordinates and potentially orientation by recognizing subject matter.

In another embodiment, a person associated with the collection of the metadata (user) provides metadata and said user added metadata may include audio information, verbal information, where verbal information means the orally spoken information or otherwise inputted verbiage. In another embodiment, the user or one or more sensors can add reference marks to the metadata, the user can also add significance scores. Significance scores are provided by the user and are quantitative or qualitative. It is contemplated that quantitative scores will be more common. One objective is to capture a user's perception. Thus, if a user sees something, and it appears “amiss” but the user cannot identify what is exceptional or why it seems significant that a door is ajar, the user can still make a note of it (such as: “something odd here”) and later on if it is discovered a crime was committed the police can look at metadata and contact a person who might has seen something. Upon questioning the person might be able to identify why something seemed odd.

Although the system can work strictly on position, and user specified observations, it is often desirable to include an image capture device. In many cases, the metadata has to be linked to the observations. If the observations are made by a camera or other image capture device or a user, the metadata is the means by which the data can be stored, accessed, retrieved, searched, and reviewed. When there is image data the metadata is ideally linked with the associated image data.

It is further contemplated that user will earn rewards for participating. The rewards could be tied to subscription fees, wherein customers pay as a required as a prerequisite to accessing the associated image data. In another embodiment, a user's contribution of content could serve as the basis for access to other user's content.

In another embodiment a system for capturing and indexing information includes an image capture component, such as a camera (sill or motion), a geographic position indicator (terrestrial or non-terrestrially based; a clock (optionally interfaces with a receiver for receiving updates as to the time), a directional indicator such as a compass or signal source direction identifier, such as a radio direction finder, a local database, and a central database. The databases can use any now know or later developed storage means. Wherein the image capture component provides an image signal to the at least one local database; the geographic position indicator provides geographical signal to the at least one local database, the clock provides a time signal to the at least one local database, the directional indicator provides a directional signal to the at least one local database and the at least one local database associatively couples at least one of the geographical, clock, and directional signals with the image signal, and at least on local database conveys data to the central database.

In another embodiment, the central database is a distributed database, such as the Internet or other distributed database, in some cases the database may be localized to an area, but tied to other geographic areas. As indicated above, it is contemplated that system for capturing and indexing information determines geographic position based on terrestrially based signals.

In another embodiment, the central database is searchable by time, location, and direction, or any combination. Searching may also be permitted based on user or specific image capture device. This could be used by law enforcement to catch kidnappers, vehicle thieves, or track fugitives. In most situations, in the interests of preserving privacy, a user would have a means to disable at least one of the data collection systems. In addition, the system could allow for complete anonymity. The search simultaneously allows for a narrow value and a broad value, such as a broad time but narrow location. For instance, a freeway sign is discovered to have been defaced between 10 PM and 6:00 AM. A search of the eight-hour period (broad) and the specific location (narrow) may allow law enforcement to determine when the activity occurred and possibly even identify people or vehicles of interest. This would be a situation where the narrow value is a location and the broad value is a period of time. Naturally, it may be desirable to collect as much information over a large geographical area at a given point in time. For instance, if a plane crashed at 9:07 AM it may be desirable to retrieve signals from as many sources as possible in the area of the crash between 9:03 and 9:12 AM.

A search protocol would allow an operator to identify an area of interest, and draw a circle outward. The search could then be narrowed by time and the search algorithm would automatically query the metadata for results where the image capture device was pointed toward the area of interest. In practice, the algorithm may initially identify all the systems with the circle; this could be done with location detection searching. A following step would include seeking all the image capture devices pointed toward the area of interest. In this situation an image capture device to the west of the point would be pointing east, if the image collection device was to the east, it would be pointing west etc. An area around the area of interest would be definable so as to indicate acceptable deviations form pointing directly at the point of interest. In one embodiment, the acceptable variation will be a function of the image capture device field of view. A more distant image capture device would be more likely to capture the point of interest if it is pointed in the correct general direction, while an image capture device that is nearer would have to more closely point to the area of interest.

In another embodiment, the present invention provides a system for capturing and indexing information. The system includes a terrestrially tethered airborne support; the support will generally be optimized for weight minimization. An aluminum or titanium rod or tube is one possible embodiment. Magnesium alloys and other aviation materials will also provide adequate results. The system further requires at least one image capture device, it is generally contemplated that a plurality to image capture devices, optionally operatively sensitive in a variety of wavelengths including visible, generally about 400 nm to 700 nm and near infrared 700 nm-2 micrometers, mid infrared 2-25 micrometers far infrared 25 micrometers to a 1 millimeter and higher, into the very far infrared, sub-millimeter and even microwave. Although the non-visible electromagnetic radiation capturing devices are suitable for many or all of the image capture devices disclosed herein they are especially appropriate with this embodiment which is contemplated for a variety of uses including covert surveillance and non-covert surveillance applications. As with other embodiments, there is at least one metadata collection component and at least data transmission component. In this case, a wireless transmission component may be especially desirable for logistical and operational reasons. The terrestrially tethered airborne support is configured to support the at least one image capture device, metadata collection component, and transmission component, and the at least one metadata collection component includes a metadata collection component integrated with the image capture device. Integrated at least to the extent that the data from the image capture device is interrelated with the metadata. The terrestrially tethered airborne support can take may forms including a lighter than air vehicle, such as a balloon, a Dirigible, or a blimp. In another embodiment, the airborne vehicle can be a kite or powered aircraft. In the case of powered aircraft the power may be carried, delivered in real time (electricity or fuel) delivered and stored, or transmitted as mechanical power, as by a rotating non-rigid shaft or cable.

A damage detection component associated with the terrestrially tethered airborne support. This could include a patterned crisscross conductive web, a projectile, such as a bullet would have to break two elements in the web in order to penetrate the web. To do this there would be patterned conductors running in an arbitrarily horizontal and substantially vertical direction. A thin insulating layer could isolate the horizontal and substantially vertical layers. The resolution of the patterns would be such that a projectile could not get between the line lines in either direction. When a projectile severs the conductive pattern a perfect coordinate location for the point of severance is provided in knowing which two (or more) lines were severed. The size of the projectile is also known based on the number of wires severed. When the projectile exits (if it does) the source of the projectile is knowable by knowing the orientation of the airborne support and the line between the entrance and the exit. The velocity is also known by comparing the time between entrance and exit and knowing the diameter (or distance) between entrance and exit points. It is contemplated that this system could be used in vehicles (terrestrial and airborne) including automobile and trucks as well as airplanes and helicopters. This feature may be especially useful in a device used to draw fire and identify the position of the shooter. Possible with almost pinpoint accuracy when the position of the web and the point of entrance and point of exit are known. In a battle situation, this could serve as the basis for an air-strike or other attack.

In another embodiment of the present invention, the system for capturing data from geographically dispersed areas includes a means for recording detected data. This could be an audio recorder, a data recorder, an image recorder, or other recorder, and a means for capturing and storing data. This could include a thermometer, a camera (responsive to a variety of wavelengths) a position sensor, a radiation detector, proximity sensor, an RFID reader, RFID transmitter, RFID detector a particle detector, a gas detector, etc. The system also provides a means for associating metadata with recorded image data, this can take one or more forms. Location, time, speed orientation could all be embedded into the picture. Audio could similarly be tied to the picture. Unlike existing systems where the metadata is tied to the image, the metadata has to be separable for the purposes of allowing a search, therefore there is a means for providing the metadata to a database. While the metadata may be provided with the actual data, the metadata is searchable. The search criteria ideally includes every metadata component, however even one component is sufficient to gather significant functionality. Time and location are among the most common factors used in narrowing a search.

In another embodiment the means for recording detected data and the means for capturing metadata are configured to convey recorded detected data and captured metadata to the means for storing data; and the means for associating meta data with image data is configured to temporally inter-relate the recorded image data with associated metadata, and the means for providing the meta data to the database provides the metadata to a searchable database. In a preferred embodiment, the means for providing metadata to a database allows the data to be provided anonymously. This could allow anonymous uploading, and also uploading and using a pseudonym to post the data. In this way, payment could be had for the upload. Payment may be conditioned on number of request for data or other factors. It is contemplated that the metadata is searchable using at least one of the following criteria location, time, coordinates, orientation, keyword, and category, or any one of these, or any combination of these or none of these. Other metadata that may be searched for includes temperature, predominate color, or user added tags.

In yet another embodiment the system for capturing data from geographically dispersed includes at least one of the following, satellite based coordinates, terrestrially determined coordinates, user defined location, time, orientation, and subject matter. Wherein the recorded data includes human observed data, including at least one of: audio information, verbal information, reference marks, and significance scores. Significance scores will usually be added by the user who collects the data, but may also be added by the system. System added significance scores could include periods of rapid acceleration or rapid deceleration, intense heat or cold, rapid changes in temperature, or sensor input, including detection of radioactive, chemical, or biological components.

### DETAILED DESCRIPTION OF THE PREFERRED EMBODIMENTS

The following description, taken in conjunction with the referenced drawings, is presented to enable one of ordinary skill in the art to make and use the invention and to incorporate it in the context of particular applications. Various modifications, as well as a variety of uses in different applications, will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein. Furthermore, it should be noted that unless explicitly stated otherwise, the figures included herein are illustrated diagrammatically and without any specific scale, as they are provided as qualitative illustrations of the concept of the present invention. The description of the preferred embodiments has been presented for purposes of illustration and description, but is not intended to be exhaustive or limited to the invention in the form disclosed. Many modifications and variations will be apparent to those of ordinary skill in the art. For example, a variety of other materials, sensors, sizes, and shapes would be utilized without departing from the spirit of the above-described embodiments. The embodiments presented herein were presented in order to best explain the principles of the invention and its practical application, and to enable others of ordinary skill in the art to understand various embodiments and various modifications suited to a particular use.

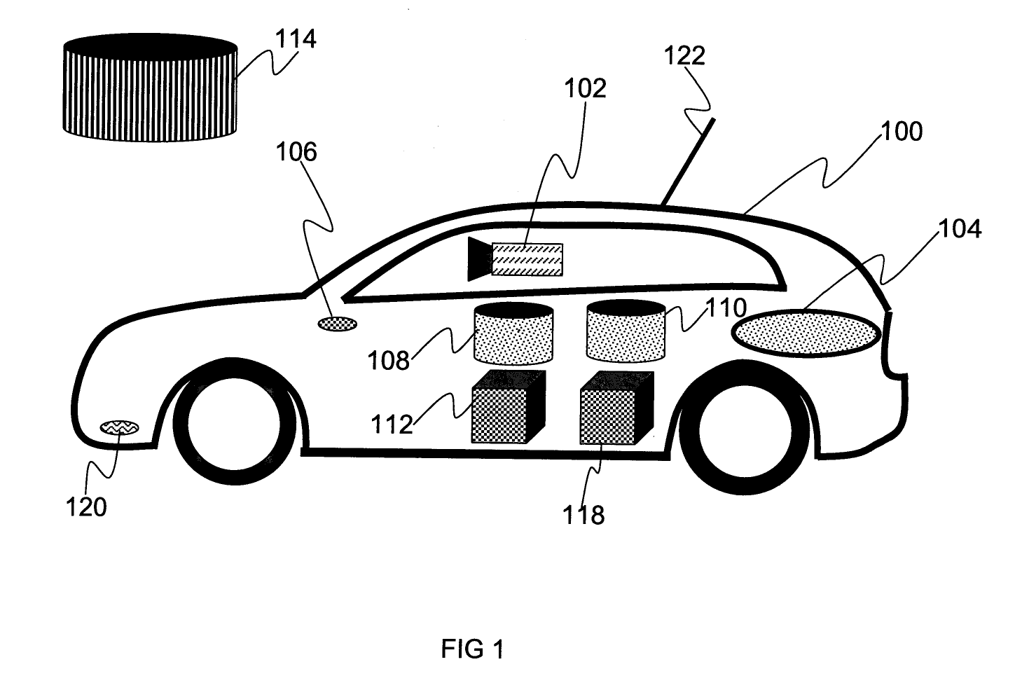

In FIG. 1 an embodiment of the present invention includes a vehicle 100 equipped with one or more video cameras 102, the video cameras ideally include the ability to detect electromagnetic radiation in the IR range. The camera is associated with a number of sensors 104, including, for example, a position locator such as a GPS, a compass, a clock, a particle detector, analyzer etc. The camera may also be interfaced with a human activated sensor 106 which allows a human, a user, to annotate a captured image or image stream which is stored in a captured image database 108. The annotation can be in the form of voice or symbols. The sensors 104, 106 provide metadata. In this embodiment, the metadata stored in a local metadata database 110 and wirelessly transmitted via a transmitter 112 to a database 114. Transmissions may occur at predetermined intervals, when requested by a consumer (pull), or when requested by a user (push). The database 114 is accessible by consumers. The local metadata database 110 is tied to the image or image stream which is stored in a captured image database 108 and can also be wirelessly transmitted. Commonly, the metadata database 110 will be transmitted at predetermined intervals and the image or image stream which has been captured in the image database 108 will be transmitted using a separate transmitter 118 which uses a wire 120. In most cases the wire 120 based download will occur at home, shopping, or at a gas station. The separate transmitter 118 need not be wired and may be wireless using the separate transmitter 118 to drive an antenna 122. In this embodiment, the transmitter uses a lower power high speed broadband link, which is set-up at a gas station, home or business. Since virtually all consumers use gas stations, a gas station would be a logical choice. Further, if the user is to be compensated for providing the data the gas station could award immediate cash or food/merchandise incentives to the user.

In another embodiment of the present invention the system for capturing data from geographically dispersed areas includes a means for recording image data 102. A common CCD camera, video or still, would work. The detected electromagnetic radiation spectrum is contemplated to range from visible deep into the IR and even into mm-wave regions. Although CCD would be one system (at least in the visible and near infrared regions other systems may be more appropriate at higher wavelengths), other image capture devices may also be used. Still capture cameras, including film cameras, infrared film cameras, infrared focal plane array cameras, and other cameras could all be used. The basic requirement is that the means for recording image data is that it respond to incident photons. The exact device will vary by application and objective. Capturing the image data is only one step, albeit an important step. After the image data is captured, it needs to be provided to a means for storing image data 108. Storage systems, in some cases will be dependant on the image capture device (35 mm film systems for example) in other cases the storage medium may be more discretionary. A solid-state storage system, with its reasonable power draw, mechanical simplicity, and reasonable cost is a desirable choice. Capturing and storing the image data are critical to the system, but system utility requires a means for classifying the image data. The present invention may use a variety of software pattern recognition algorithms, color recognition algorithms, and environmental sensing systems to create a metadata file that is associated with each stored image. The metadata is stored in the metadata database 110, the metadata is linked to the image which is stored in the image database 108. In some embodiments, the metadata is stored in the same database, that is the metadata database 110 and the image database 108, are the same database. In other embodiments, the metadata is stored remotely such as at a remote database 114, however in all cases there. is a system to allow for the matching of the metadata with the stored image. The means for associating metadata with recorded image data may include, by way of example, a time stamp. Alternatively, common sequential filenames (with different extensions or in separate databases) is another example. Additionally, the metadata must be provided to a database where it can be searched, indexed, classified, and otherwise processed. The submission to the database 114 can be done using any technology, including, by way of example only, wireless, and wired transmission. The data may be submitted anonymously, or pseudo-anonymously, or otherwise. The metadata may be electronically generated and have safeguards to prevent a user from being able to alter the metadata, or allow alteration but allow for a secure audit trail indicating who changed what and when. In other embodiments, the metadata is entirely created by the user. The database may be a distributed database, a central database, or a combination. In the case of a combination, the metadata may be stored in a central database while the image data may be stored in a distributed database, or any other storage scheme. Access to the distributed database may be controlled differently than access to the central database, and access to metadata and image data may be varied. Control may be based on terms of use or other criteria, including payment. In one embodiment, a consumer 116 may search for certain metadata, such as: time, orientation, and location for example, and then flag metadata corresponding to data of interest. Conversely, image data could be flagged and the associated metadata could be accessed. In all cases, access to all data may be controlled, with cost, or conditions preceding access to the data.

In some situations, the metadata may include location, time, and subject matter. Location and time may be provided by satellite or terrestrial systems as well as systems, which record speed and direction and a clock or other chronometer. Such a system, in a simple form would be a GPS unit, and a clock. Alternative embodiments way use image recognition software to identify known landmarks, and determine location from size, direction, and relative position. In other embodiments, a user records metadata and the recorded metadata is stored, optionally as voice, or as data. The conversion to data may be accomplished with voice recognition software. In some cases, the metadata will be stored in several forms. Additionally, voice data could be stored with the image, data and indexed using the same metadata as is used for the image. The image or the metadata may include user added tags. These tags may be audio based (speech, tone, etc) or flags, which correspond to items of potential significance. An example of this would be a motorist who observe a cardboard box adjacent to a freeway, but not in traffic lanes.

In one embodiment, the system includes a vehicle 100 and at least one camera 102 and a GPS unit 104. In operation, the camera 102 records images and stores the images coupled with GPS data and other sensor data including direction that the camera was pointed as well as time. At an interval, the metadata may be uploaded to a database 114 and the database could be accessible while it is in the vehicle. Such a database would be queryable based on reported location, a unique identifier, or other criteria. Database 114 users potentially include law enforcement, traffic control departments and news organizations and others “consumers.” Vehicle operators or users set profiles, indicating who has access to what data and under what conditions, the settings are optionally made anonymous. The metadata serves as the introduction to the actual images. Thus, the metadata, might give a location “5^{th} and Main” or “Mile Marker 234” a time “3:25 PM” and a brief description of the static scene, “Metropolitan museum north entrance” or N38°48.17706, W077°3.8385 or “southbound lanes of I95 at Mile Marker 134.” The brief description could be based on a database that correlates GPS data to a location or landmark, or could be based on data collected, as with voice data, image recognition, or other means. It is also contemplated that the metadata may be linked with a unique identifier, which is correlated with the metadata. By unique, it should be understood that this could be a globally unique number (no two ever identical over a given period of time) or system unique (unique within the system). A globally unique number is generally the more preferred option. However, in some cases a locally unique number may have utility.

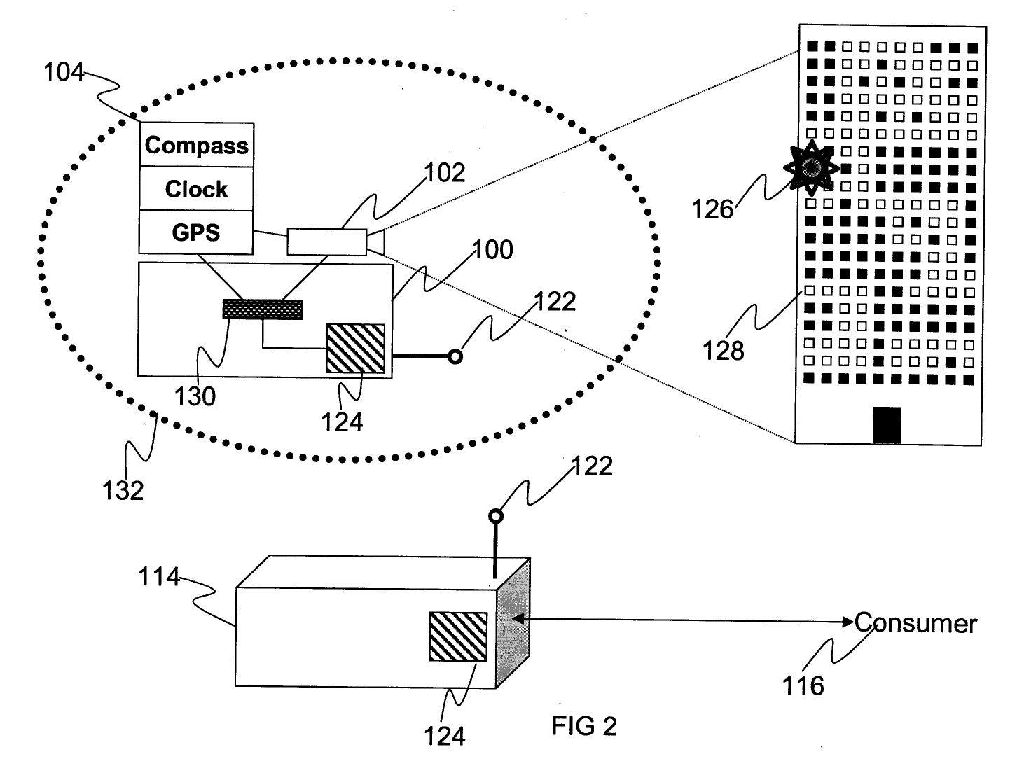

Referring now to FIG. 2 where a vehicle 100 is part of a vehicular system 132, which includes a video camera 102 a plurality of sensors 104 a processor 130 which receives output signals from the sensors 104 and the camera 102 and associates the sensor 104 supplied metadata with camera 102 supplied image data. The image data, metadata or both can be transmitted using the transmitter 112, the transceiver 124 can use new or existing infrastructure to convey the image data and metadata to a database 114. Some vehicles equipped with ONSTAR® or similar system could use the existing infrastructure to convey the information to a third party database (not shown) or to the system database 114. The antenna 122, like the transceiver 124 can be a custom/new installation or part of a pre-existing system. Functionality allowing a consumer 116, to query the vehicular system 132 is optionally included. The query can be responded to using metadata, or image data or both. In operation, the system is provided where the vehicle 100 is equipped with a camera 102 and a plurality of sensors 104 in this case the sensors include a satellite based positioning system, a clock and a compass, the sensors 104 provide an output, which is characterized as metadata. These sensors 104 may be part of a single unit or a plurality of units. The metadata serves to annotate the image data, and in this embodiment, the metadata is transmitted wirelessly to a database 114. The transmission can occur on a continuing basis, on an intermittent basis or on a scheduled basis. The transmission may also be externally prompted, either by a user, or by a consumer 116. In operation, a user may wish to indicate to a consumer 116 that he is in a certain area, especially if he has observed an event of interest, such as a fire or a traffic accident. In a hypothetical, a driver of a vehicle 100 observes flames 126 in a high rise 128. He immediately notifies local authorities using a portable communications device (such as a cell phone). The authorities (or other consumers) immediately undertake a query of all user's vehicles 100 in the proximity of the reported fire. The systems transmit metadata to a database, which the consumer (local authorities) access. If position and orientation are promising the consumer may request the data associated with the metadata. The initial response would be all vehicles 100 meeting the criteria sending metadata. Authorities (or customers) would thereafter after request the full data (image data) from the vehicles 100 showing the most potential for having captured the desired footage. In time, all the metadata and image data will be added to the database and investigators, reporters and other consumers will be able to access the information. In some especially robust embodiments all the data and metadata are continually being transmitted. The wireless electromagnetic radiation transceiver 124 component on the vehicle 100 may be augmented by a conventional wired dataport. The transceiver 124 is illustrated as being wireless—using an electromagnetic radiation signal, via an antenna 122, through the air. However, it is important to note that the transceiver 124 could store (or buffer) data and only respond to queries. The data could then be downloaded on a periodic basis using a medium transfer component. A compact disc, thumb drive, magnetic tape or other memory storage device is specifically contemplated. Ideally, the memory device would be re-useable and could be “swapped out” on a regular basis. In this manner, the data would be sent to a local database on a regular basis, and the transmission could occur at a time when bandwidth resources are traditionally underutilized, such as early morning hours. This option also allows consumers to selectively request certain data when it is needed and allow for subsequent transmission of data, which is of a more historical value. With respect to application, a law enforcement officer would be able to search the metadata and see if an area was under surveillance at a certain time, and in this manner, more effectively capture a criminal, or identify potential witnesses. A news station or other media outlet may want on-the-scene footage of a traffic jam, accident scene, or roadside blaze. An insurance company may be willing to pay for a videotaped record of an accident in an attempt to determine who was at fault. Air traffic controllers may want a view from the air, etc. In the event of a terrorist incident such as the Beltway Sniper, where a pair of individuals used a sniper rifle to execute people in and around Washington D.C., the system could help apprehend the fugitives. In such a situation, the present invention would allow law enforcement to contact persons in the vicinity of the shootings, and law enforcement would be provided with images that may prove helpful, if not individually, potentially in the aggregate, in identifying and isolating persons and vehicles of interest. The repeated appearance of a vehicle in a dragnet, or the observation of the same people at multiple scenes would allow law enforcement to identify persons of interest.

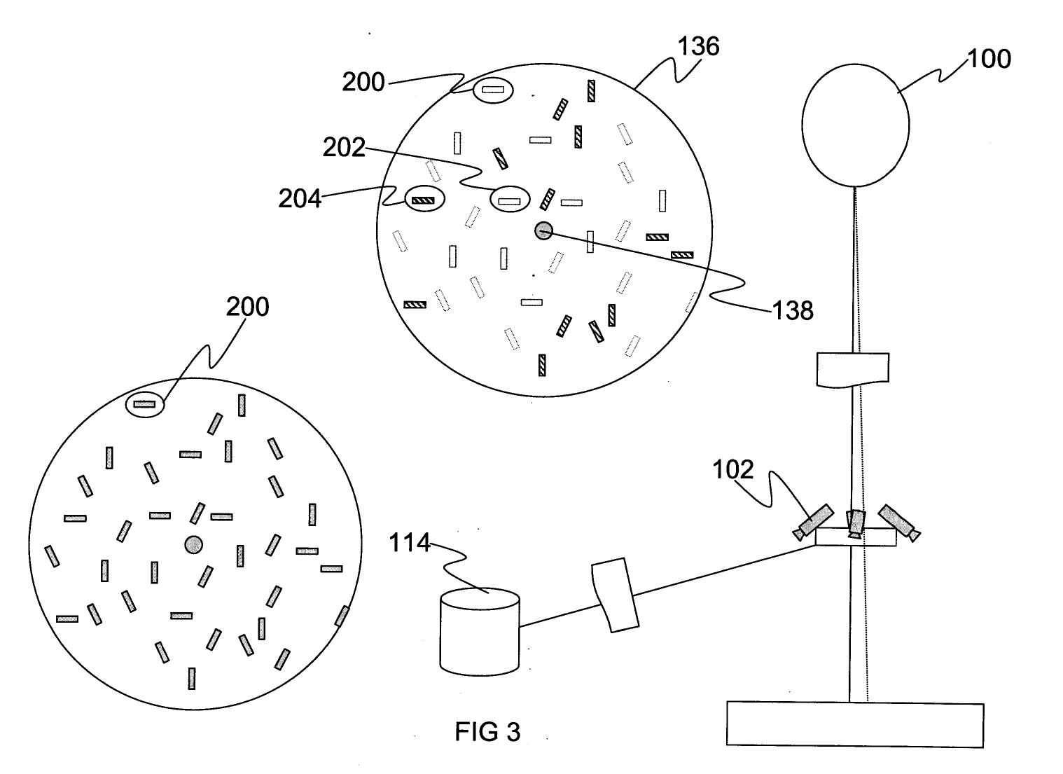

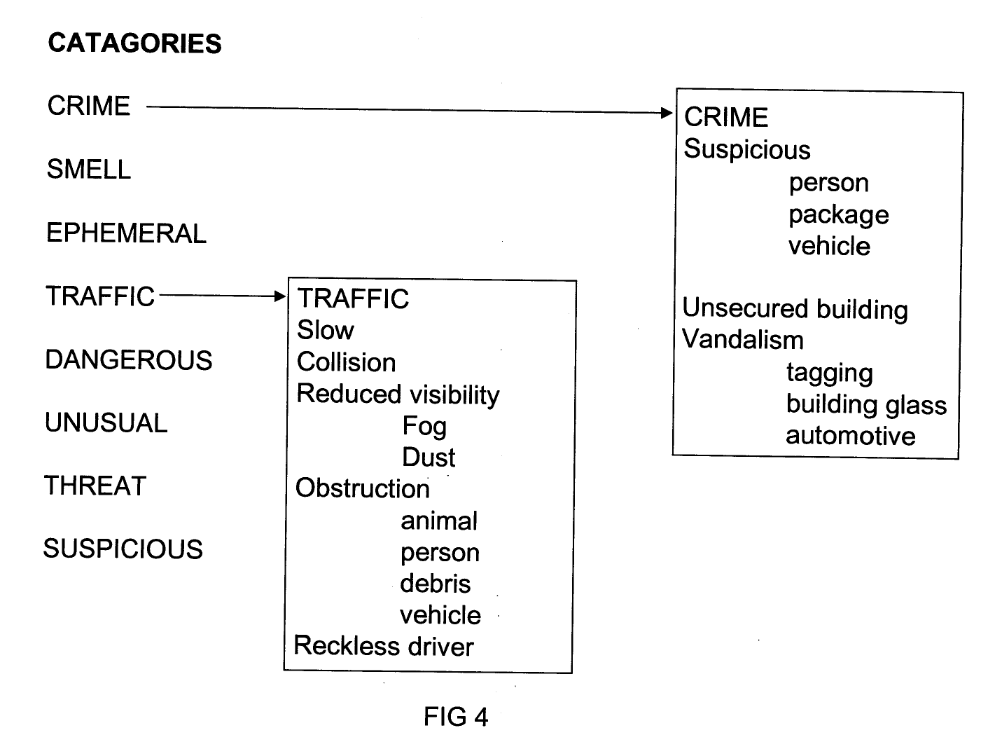

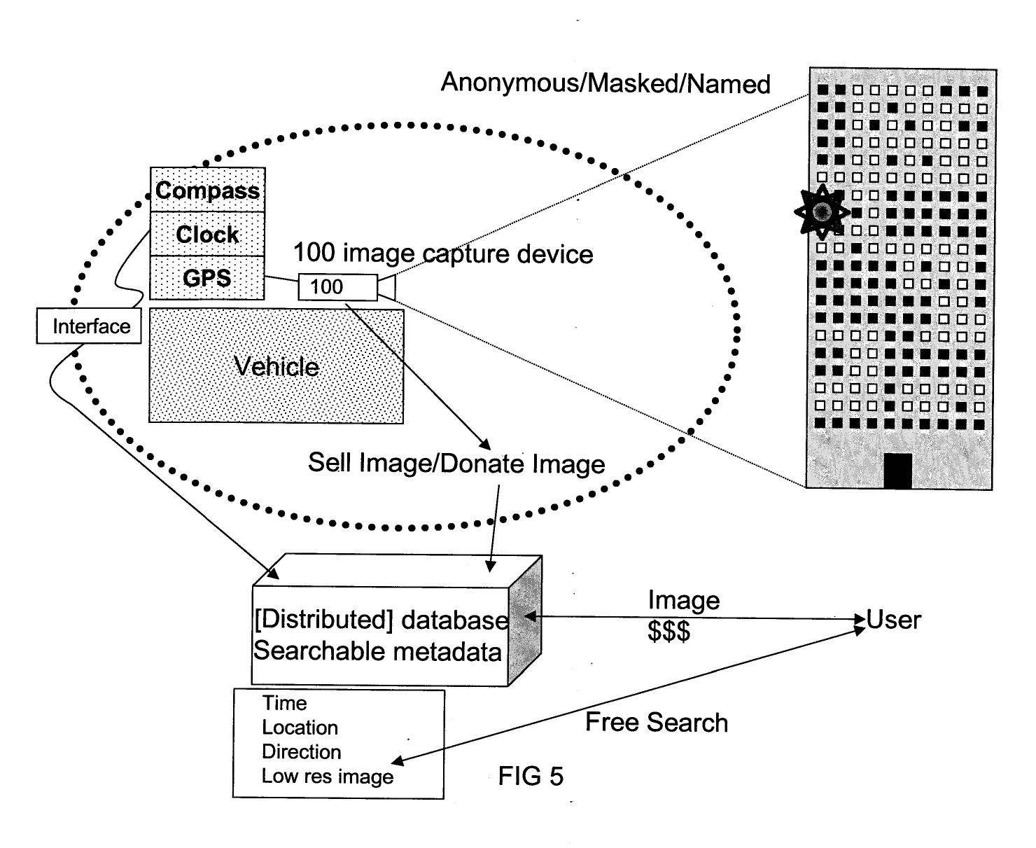

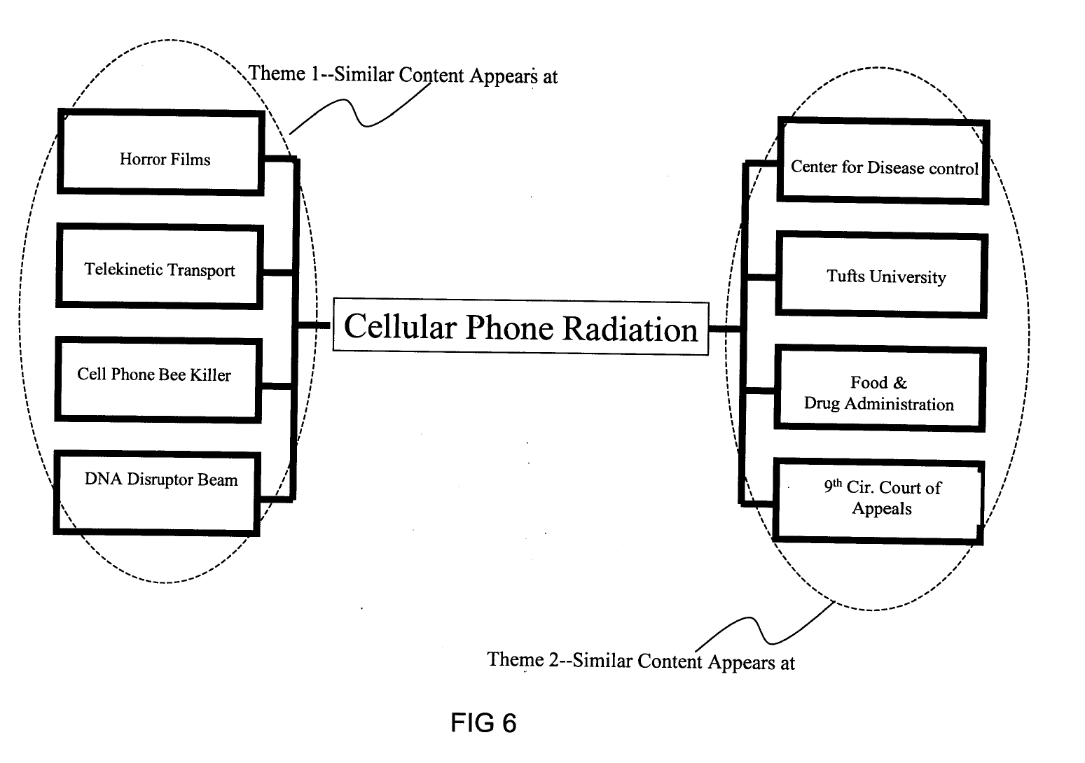

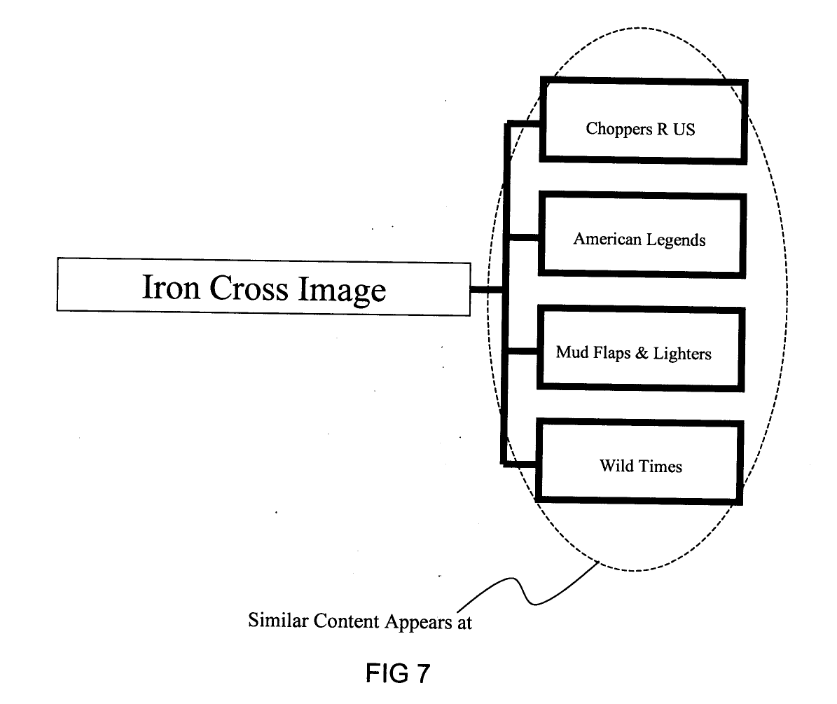

The term vehicle contemplates a motor vehicle such as a car, but vehicle is intended to encompass a balloon from which the system may be suspended. In a region where terrorism or immigration is a problem an anchored balloon could suspend an image capture device, the device would operate in concert with other devices to provide complete visual ground cover for an entire area. In FIG. 3 one embodiment using a lighter than air vehicle 100 is provided. The cameras 102 provide image data to a database 114 using either wireless or wire transmission. In either case, the data may be periodically retrieved, or communicated in real time. The tether 134 is provided as a means for anchoring the airborne vehicle 100 several tethers 134 may be employed and each may have an associated image capture device and metadata recordation device.

Data retrieval is another component of the present invention. In one embodiment, customers will be able to select a geographical area 136. The shape of the area can be a circle (shown) or a length of freeway or other area or shape. The consumer selects the area and the interval and the positions(s) of interest 138. Vehicles in the area during the relevant period are queried for inter alia orientation metadata. From a practical perspective

The database could use the metadata to compile historical data and predict commute times based on weather (slower in rain, faster when weather closes businesses), proximity to holiday, day (Friday AM light, PM heavy), time, proximity to location with seasonal employment/attendance (legislature, courts, universities, schools).

Data collected can be shared on the Internet or through other means. A subscription to the metadata, to the data, to both or neither is contemplated. Further, post collection work-up, where additional data is added by combining a plurality of data collections may be created as a values added database. This might be especially attractive to a news outlet who would like a collection of all the footage from all angles of all fires within a city on a particular date.

The collected data could be shared as data is shared on existing Internet sites, such as MYSPACE.COM™ or other site where access is controlled put information can be posted. The invention however requires that the metadata be searchable and accurately point to the actual underlying data. Thus, individual postings are possible but would represent a part of a distributed database. The present invention requires the availability of large portions of fairly banal data in order to allow for the drawing of meaningful conclusions.

Investigators may use the data to better understand how and why an accident occurred. Hobbyists may use the data to better understand what happened that people thought was newsworthy “tagged” today. Archivists may use the data to query is there a different view of the events as reported. A pet owner may query persons who were in the vicinity of the pet's last known whereabouts. Law enforcement might query users to in an effort to locate footage from vehicles in a specific region during a specific period of time. Individuals and organizations can query databases to provide footage showing traffic conditions.

Systems that a user wears or carries may operate without an image capture device, or continue to operate if an image capture device is unable to properly capture images. In such a case, the system relies solely on a user input. User input may be a general narrative, this would usually be associated with a microphone, and optionally an audio recorder, a series of coded signals could be tied to the recorder. Other systems include sensor-based systems which track a user's visual fixation. If an object appears to get more than a passing glance the metadata may reflect this. Even without a picture, this could provide evidence that there was something that the user thought was anomalous.

In one embodiment, a code signal system is provided. The code signal system is ideally coupled with an image capture system but can readily be tied only to the metadata, or even transmitted in real time, ideally with a position indicator. The indicator may be a crude triangulation step or other system. Usually a more sensitive geographical determiner will be desirable. According to a simple version of this invention, the user's mind is tapped as a detector for anomalous input. The human mind is capable of discerning thousands of variations or deviations from the normal, but often lacks the ability to specify and report the anomalies. Even if the anomalies could be articulated and reported, current data receiving systems cannot process the tremendous variety of information that is reported. This embodiment relies on a larger reporting audience and a standard reporting code. The reporting code can be queried for additional details, examples of ways to so query include, accessing associated images, accessing associated commentary, or by querying the collector of the information. Reporting codes could be established for sensitivity to certain events, threats, or information. A generic example of the reporting code, set for general observation would include a RELEVANCE SCALE, which could include a scale ranging from 1-10. The corresponding OBSERVATIONS, in this case, broken down into CATEGORIES, and further broken down into DEGREES Therefore, CATEGORIES might include CRIME, TRAFFIC, SMELL, EPHEMERAL, DANGEROUS, UNUSUAL, THREAT, FUNNY, SUSPICIOUS to name a few. Each category would then include subcategories, or degrees. Subcategories under crime:

CRIME,
Suspicious person
Suspicious package
Suspicious car
Unsecured building
New vandalism
Reckless Driver

In an example, the reporter would press 1 to activate the CRIME menu and then press 5 to report new vandalism. The collector system would then display a mark on a map corresponding to the site. As additional reporters pass the site the number of marks at the site with the same report (new vandalism) will increase. Once a certain threshold is reached, a notification signal might be sent to a law enforcement agency or a business owner or homeowner in the area. This system allows for the early identification of graffiti or a broken window for instance. A shop owner can make prompt arrangements to have the graffiti cleaned up or a broken window repaired.

In the case of a TRAFFIC report
Slow
Accident
Debris in the road
Reduced visibility
Fog
Dust
Animal/person in the roadway
Reckless driver
Racing
Vehicle stalled in traffic

It will be appreciated that there will be an overlap between CRIME and TRAFFIC-reckless driver. In this case, a report of a reckless driver reported many times along a stretch of freeway may prompt additional enforcement in the area. By setting a threshold above an average, it would also be possible to correlate reported behavior with traffic accidents. Such reporting may help traffic engineers better understand the source of traffic incidents. For instance, an average amount of reckless driving marks coupled with an above average number of accident marks would suggest that the road design is a target for optimization. Conversely, an above average amount of reckless driving marks coupled with an above average number of accident marks would suggest that the road may be a candidate for additional signs indicating the speed limit or the need for an increase in the number of traffic control systems or practices. The system is also useful as an aid to the early identification of roadway obstructions. In the case of a stalled vehicle, a tow truck is dispatched in a timely manner. As importantly, media outlets can dispatch aircraft to areas reporting slowing or accidents or other events which adversely affect traffic flow.

SMELL,
Natural gas
Something rotting
Gasoline
Fuel
Unknown foul chemical
Unknown foul natural
Pleasant natural
Pleasant chemical
Food
Waste

In the area of olfactory sensing the human nose is still vastly superior and more widespread than any chemical detecting technology. In the case of SMELL the system is contemplated to have a particularly robust “query protocol” this would allow an operator to query a user in a geographical region if they have detected any smell. Users could be compensated for their responses. Deposits would be made directly to a users holding account or bank account or to a collective where a group of users would agree to split proceeds. The latter option would be useful in ensuring user anonymity. The system would have marketing benefits for restaurants that would be able to gather feedback about the number of people who smelled the food, and potentially use the positive attribute as a means to drive customers to a venue. Also, people who enjoy the outdoors could identify areas of particularly fragrant trees, or areas with high allergen concentration. This embodiment leverages humans olfactory senses and can avoid the need for acquiring expensive sensing technology. The system is best used in conjunction where the human nose or human senses are engaged.

EPHEMERAL,
Sunset
Vehicle without headlights
Unusual person running
Unusual vehicle in motion
Low flying aircraft
Ignored traffic signal
Unusual noise
Firearm discharge

Signals in the EPHEMERAL category are most commonly used for identifying places where events of interest are likely to occur on a repetitive basis. For instance, a spectacular sunset as seen from MALLORY SQUARE™ on Key West would potentially be recorded on average N times per day for a given period of time. Tourists might conclude that the site is worth visiting at sunset. The system has a built in monitoring system because the users and not the owner of the venue control the system. The system is also useful for in identifying an area where firearm discharge is common, or time when firearm discharge is common. For instance, in a specific neighborhood during certain hours. A transient unusual noise or odor could be tracked through town and be used to determine the whereabouts of an object or person of interest. In a crowd, a running person with a shrieking baby may momentarily attract attention and then be forgotten, thereafter it is discovered that a child was kidnapped, the record, users memory and associated images (if user or images are available) may prove helpful solving the crime. Additionally, advertising effectiveness could be gauged by deliberately creating a distraction and monitoring response.

DANGER,
Person
Suspicious Object
Unsecured wall/cliff
Deep water
Uncontrolled domestic animal
Poorly lit area
Obstruction in the road
Undertoe
Hornet's nest
Poison Ivy

The DANGEROUS designation is used in the case of a situation where a user perceives that a danger exists. Dangers can be manmade or natural. A washed out road, poorly lit parking facility, road obstruction, or even a hornet's nest are reportable. Special interest groups could also be created where allergy suffers could report areas of high pollen/mold counts.

UNUSUAL,
Person
Behavior
Object
Smell
Sound
Weather
Event

UNUSUAL is the class, which would often serve as the default. Its purpose is to allow users to report “odd” or “unusual” events, which individually seem insignificant, but when viewed in connection with other events or in the aggregate with other reports may be significant. Many people see events or people and are troubled by something, it is not enough to warrant a call to an emergency operator, but it makes an impression. The UNUSUAL may also be used as a means to capture anecdotal information to share with others. This would be especially so as a means to share information within a familial, social, or cultural circle. For instance a letter carrier, utility worker, dogcatcher and trash collector, may make notes about domestic animals, open trenches, and bad sidewalks paranoid customers and troublesome corners. A substitute letter carrier, could access localized information and be apprised of what others who traversed the same route, in a similar, or the identical role, identified as unusual. With time, a normalizing function could be applied to individual users to compensate for differences in observational power and for variations in perceived severity. The normalization would occur naturally if sufficient data points are collected, however individual normalization allows for more meaningful results with fewer data points.

The system working with user supplied OBSERVATIONS, audio and video as well as other sensors, allows for a unique view of the dynamic events in a geographical area. The data is useful in real-time and as historical data to aid in predicting the future.

A system includes a vehicle and at least one camera and a GPS unit, the camera records and images and store the images coupled with GPS data, direction that the camera was pointed as well as time. At an interval, the meta data may be uploaded to a database and the database could be accessible. Database users including law enforcement, traffic control departments and news organizations and others “users” (profiles settable and optionally anonymous). The metadata would serve as the introduction to the actual images. Thus, the metadata might give a location “5^{th} and Main” or “Mile Marker 234” a time “3:25 PM” and a brief description of the static scene, “Metropolitan museum north entrance” or “southbound lanes of I95 at Mile Marker 134.”

A law enforcement officer would be able to search the metadata and see if the north entrance of the Metropolitan art museum was under surveillance at a certain time and in this manner, more effectively capture a criminal. Similarly, a news station may want on-the-scene footage of a traffic jam, accident scene, or roadside blaze. An insurance company may be willing to pay for a videotaped record of an accident in an attempt to determine who was at fault.

In the event of an incident such as the beltway sniper persons in the vicinity of the shootings would be able to provide law enforcement images, which may prove helpful, if not individually, potentially in the aggregate, in identifying and isolating persons and vehicles of interest. The present invention includes embodiments that record and store visual data and meta data, providing the metadata (optionally anonymously) to a database, wherein the metadata (time location) allows a database user to determine if the data is of interest; and the collecting entity may limit permission of the database user to access the data with conditions.

The device supporting a camera (in embodiments including a camera) could include a an automobile, a balloon a person, who might wear the camera as part of an article of clothing, an animal especially a domestic animal or an animal that frequents roadways or other places of potential interest. Scavengers (crows for instance) along the roadway may be enlisted. Of course military vehicles could also be equipped, a feature which might be useful subsequent analysis and long term change profiling. For instance, it might be observed that on most days, people line the street but on days when vehicles are attacked, the number of persons lining the street is reduced and has a different composition. A common cellular phone may mind application as a reporting system, wherein a user reports observations (visual, audible, olfactory, and contextual) and the phone records the observations and generates the requisite metadata. While GPS systems could be included as a means for capturing location based metadata other systems including terrestrial based triangulation, relative signal strength, landmark location, beacons etc could also be utilized. Components could be built into the phone or other module (such as a camera) including the location sensor, and other metadata collectors, and also primary sensors such as Geiger counters, gas sensors, biohazard sensors, chemical sensors, radiation emission sensors, tagged merchandise sensors etc. In the case of tagged merchandise, a piece of merchandise could be tracked, or a bank robber, carrying a marked bundle of bills could transmit a short-range signal, thus allowing law enforcement to track a fugitive's path. In another embodiment a particulate detector is provided, the particulate detector analyses particulate and monitors variations in mean particulate size, or actively test for particulate within a certain size range. Especially where such a size range is consistent with toxins, contraband, items of interest, or activities
Microphone
Camera
Thermometer

The present invention includes an embodiment that could be suspended from a balloon, or other lighter than air vehicle, mounted in an automobile, mounted in a piloted aircraft, or associated with a worn garment or item jewelry etc.). In another embodiment, the present invention allows a camera operator to add a “tag” corresponding to canned messages or a “relevance scale” the relevance scale could be made relevant be considering a host of situations and “normalizing” the responses for each person against a standard.

The camera system could also be mounted in an article of clothing or as an accessory. In a preferred embodiment the system would be mounted in a hat or other garment which would rarely be obstructed by garments. Outer garments are also desirable. Jewelry, footwear, eyeglasses, hearing aids and other similar devices are also desirable choices inasmuch as it is unlikely the wearer will inadvertently forget the system.

The database could use the metadata to compile historical data and predict commute times based on weather (slower in rain, faster when weather closes businesses), proximity to holiday, day (Friday AM light, PM heavy), time, proximity to location with seasonal employment/attendance (legislature, courts, universities, schools).

In another embodiment an Internet based share feature would allow a person of an organization, or group with common interests, shared beliefs etc. Users can form circles of friends with whom they will share data, and organizations can pay people to allow the cameras to be installed. Use of, and access to, the information collected may be allowed with conditions, such as how the material will be used, whether it will be personally identifiable and which groups get which access.

In some embodiments, the data will be stored internationally so as to reduce the likelihood that the information would be subject to the power of a subpoena.

In some embodiments image recognition software may be employed to generate metadata and assist with image classification, even when the images are existing images. It is specifically contemplated that a large database of images (including, without limitation distributed databases such as the Internet) is subjected to an image recognition protocol and provides searchable metadata which is tied to the image. It is also contemplated that a matching protocol will be provided which can search databases (including, without limitation distributed databases such as the Internet) and identify images, which are substantially similar or include substantially similar shapes, substantially similar color patterns, or substantially similar color shades. It is specifically also contemplated that images may be searched using user provided images or descriptions of user provided images. Thus, a user may draw the silhouette of an eagle with wings pointed skyward and the program would look for comparable images. A neural network based training could be used to aid in identifying specific images. In such a system:
A distributed database including a plurality of images
A protocol for classifying the images
A means for associating metadata with the images based on content wherein content includes at least one of the following.
Color in the image
Colors in the image
Ratios of colors in the image
A shape in the image
Shapes in the image
Ratios of shapes in the image
The combination of a shape and a color in the image
The combination of shapes and a color in the image
The combination of a shape and colors in the image
The combination of shapes and colors in the image
The resultant metadata includes at least one of:
A description such as an adjective and a noun
A description such as a noun
A description such as a verb and a noun
A description such as a verb
A description such as an adjective
A description such as a verb, a noun, and an adjective.

A related concept provides a search engine that provides a display that shows the sources of the content of the webpage. Not just links but other sites which include substantially similar text. Thus, a site that includes data that appears on the USPTO website, the NOLO website and the California State Bar website would display as a site with ties to those sites. In the case of a searcher entering “Iron Cross” the search engine would identify THEMES. The first THEME might be a historical or cultural theme, in this theme would be sites with content similar to that found in sites related to museums, sites related to history, site devoted to analysis and commentary on cultural symbols and sites related to WWII Germany. Another theme might be motorcycle clubs, and yet a third theme may be apparel. As plagerism detection software gets better it will be increasingly easy to identify where content has its origins or content which is similar. A search of Paris Hilton would identify themes 1. GEOGRAPHY, a hotel in the city in France and 2. CELEBRITY an heiress to the Hilton estate. Within the themes content from the GEOGRAPHY theme would draw content from travel websites, accommodation websites, tourism websites, etc. While CELEBRITY themed websites would draw content from gossip columnists, tabloid articles, personal fashion commentators, and adult oriented websites. A searcher would enter the search terms Paris Hilton may initially encounter a page with a choice of Themes. The presentation may be vertical columns (Geography on the right and Celebrity on the left) or a hub and spoke arrangement with the search term Paris Hilton in the hub and each spoke having an end “hub” or “secondary hub” corresponding to a theme and this and this secondary hub allowing for additional spokes and tertiary hubs, in an ongoing manner. Again the content for the themes is drawn from the source of the content which appears on the pages.

1. A system for capturing data from geographically dispersed areas comprising:
a means for capturing image data;
a means for storing image data;
a means for capturing meta data;
a means for storing meta data,
a means for associating meta data with recorded image data; and
a means for providing the metadata to a database;
wherein the means for capturing data is configured to convey captured image data to the means for storing image data;
the means for capturing metadata is configured to convey captured meta data to the means for storing metadata;
the means for associating meta data with image data is configured to temporally
inter-relate the recorded image data with associated meta data, and the means for providing the meta data to the database provides the meta data to a searchable database.

2. The system for capturing data from geographically dispersed areas of claim 1, wherein the means for providing metadata to a database allows the data to be provided anonymously.

3. The system for capturing data from geographically dispersed areas of claim 1, wherein the metadata is searchable using at least one of the following criteria:
location;
time;
coordinates;
orientation;
keyword; and
category.

4. The system for capturing data from geographically dispersed areas of claim 1, wherein the metadata includes at least one of:
satellite based coordinates;
terrestrially determined coordinates;
user defined location;
time;
orientation; and
subject matter.

5. The system for capturing data from geographically dispersed areas of claim 1, wherein the metadata may include user added metadata and said user added metadata may include:
audio information;
verbal information;
reference marks; and
significance scores.

6. The system for capturing data from geographically dispersed areas of claim 1, wherein the meta data is linked with the associated image data wherein a subscription is required as a prerequisite to accessing the associated image data.

7. A system for capturing and indexing information comprising:
an image capture component;
a geographic position indicator;
a clock;
a directional indicator;
at local database;
a central database;
wherein the image capture component provides an image signal to the at least one local database; the geographic position indicator provides geographical signal to the at least one local database, the clock provides a time signal to the at least one local database, the directional indicator provides a directional signal to the at least one local database and the at least one local database associatively couples at least one of the geographical, clock, and directional signals with the image signal, and at least on local database conveys data to the central database.

6. (canceled)

8. The system for capturing and indexing information set forth in claim 7, wherein the central database is a distributed database.

9. The system for capturing and indexing information set forth in claim 8, wherein the distributed database is the internet.

10. The system for capturing and indexing information set forth in claim 7, wherein the geographic position is based on terrestrial signals.

11. The system for capturing and indexing information set forth in claim 7, wherein the central database is searchable by time, location, and direction.

12. The system for capturing and indexing information set forth in claim 8, wherein the search simultaneously allows for a narrow value and a broad value.

13. The system for capturing and indexing information set forth in claim 9, wherein narrow value is a location and the broad value is a period of time.

14. A system for capturing and indexing information comprising:
a terrestrially tethered airborne support;
at least one image capture device;
at least one metadata collection component;
at least data transmission component;
wherein the terrestrially tethered airborne support is configured to support the at least one image capture device, metadata collection component, and transmission component, and the at least one metadata collection component includes a metadata collection component integrated with the image capture device.

15. The system for capturing and indexing information of claim 14, wherein the a terrestrially tethered airborne support is a lighter than air vehicle.

16. The system for capturing and indexing information of claim 14 further comprising a damage detection component associated with the terrestrially tethered airborne support.

17. A system for capturing data from geographically dispersed areas comprising:
a means for recording detected data;
a means for capturing and storing data;
a means for associating meta data with recorded image data; and
a means for providing the metadata to a database;
wherein the means for recording detected data and the means for capturing metadata are configured to convey recorded detected data and captured meta data to the means for storing data; and
the means for associating meta data with image data is configured to temporally inter-relate the recorded image data with associated meta data, and the means for providing the meta data to the database provides the meta data to a searchable database.

18. The system for capturing data from geographically dispersed areas of claim 17, wherein the means for providing metadata to a database allows the data to be provided anonymously.

19. The system for capturing data from geographically dispersed areas of claim 1, wherein the metadata is searchable using at least one of the following criteria:
location;
time;
coordinates;
orientation;
keyword; and
category.

20. The system for capturing data from geographically dispersed areas of claim 1, wherein the metadata includes at least one of:
satellite based coordinates;
terrestrially determined coordinates;
user defined location;
time;
orientation; and
subject matter; and
wherein the recorded data includes human observed data, including at least one of:
audio information;
verbal information;
reference marks; and
significance scores.
